(19) United States
(12) Patent Application Publication
(10) Pub. No.: US 2008/0118729 A1
(43) Pub. Date: May 22, 2008

(54) THERMOPLASTIC COMPOSITION, METHOD OF MAKING, AND ARTICLES FORMED THEREFROM

(75) Inventors: Jessie Adam Goyette, Chicopee, MA (US); Brian Mullen, Mount Vernon, IN (US)

Correspondence Address: CANTOR COLBURN LLP - SABIC (LEXAN/CYCOLOY), 20 Church Street, 22nd Floor, Hartford, CT, 06103, US

(73) Assignee: GENERAL ELECTRIC COMPANY, Schenectady, NY (US)

(21) Appl. No.: 11/560,543

(22) Filed: Nov. 16, 2006

(51) Int. Cl. C08G 59/02; B29C 47/00; B32B 5/00

(52) U.S. Cl. 428/220; 525/463; 525/451; 264/211.12

(57) ABSTRACT

A thermoplastic composition is disclosed, comprising: a polymer component comprising a polyestercarbonate copolymer comprising ester units of the formula

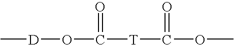

wherein each D and T is the same or different and is independently a divalent C₆₋₃₀ aromatic organic group; and carbonate units of the formula

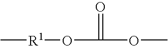

wherein at least about 60 percent of the total number of R¹ groups are a divalent C₆₋₃₆ aromatic organic group, and the balance thereof are C₁₋₃₆ aliphatic, C₅₋₃₆ alicyclic, or C₆₋₃₆ aromatic organic groups; and 0.01 to 10 wt. %, based on the total weight of the polymer component, of a polymeric compound comprising at least two epoxy groups, wherein the polymeric compound has a weight average molecular weight of 1,500 to 18,000; wherein a test article having a thickness of 3.2 mm and molded from the thermoplastic composition retains more ductility after aging at 134° C. and 100% humidity for 48 hours than an article having a thickness of 3.2 mm and molded from the same thermoplastic composition without the polymeric compound comprising at least two epoxy groups, each measured in accordance with ASTM D3763-02.

### BACKGROUND OF THE INVENTION

This disclosure relates to thermoplastic compositions, and in particular to thermoplastic polyestercarbonate compositions, their methods of manufacture, and articles prepared from the thermoplastic compositions.

Polycarbonate is a useful engineering plastic for parts requiring clarity, toughness, and, in some cases, good heat resistance, that is, stability at higher temperatures. Plastic materials with a combination of good heat stability (heat distortion temperatures of greater than 130° C.) and improved hydrostability are useful for medical applications that require high temperature sterilization (autoclave temperatures greater then 130° C.). Copolymers of polyesters with polycarbonates can provide thermoplastic compositions having improved properties over those based upon either of the single resins alone. However, incorporation of ester units into the polycarbonate backbone can lower the hydrothermal resistance of the polycarbonates, likely due at least in part to acid-catalyzed degradation. Further, upon exposure to high temperature and humidity, such copolymers can also exhibit hydrolytic instability (degradation), as evidenced by crazing, cracking, and/or lowered transparency.

Accordingly, there remains a need for polyestercarbonate copolymer compositions having improved hydrothermal resistance. Improved hydrolytic stability, in particular improved resistance to environmental stress crazing and cracking is also desirable. It would further be an advantage if such properties could be obtained together with one or more other desirable properties, such as transparency, dimensional stability, processability, and the like.

### SUMMARY OF THE INVENTION

The above deficiencies in the art are alleviated by a thermoplastic composition comprising a polymer component comprising a polyestercarbonate copolymer comprising ester units of the formula

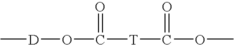

wherein each D and T is the same or different and is independently a divalent C₆₋₃₀ aromatic organic group; and carbonate units of the formula

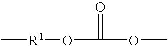

wherein at least about 60 percent of the total number of R¹ groups are a divalent C₆₋₃₆ aromatic organic group, and the balance thereof are C₁₋₃₆ aliphatic, C₅₋₃₆ alicyclic, or C₆₋₃₆ aromatic organic groups; and 0.01 to 10 weight percent (wt. %), based on the total weight of the polymer component, of a polymeric compound comprising at least two epoxy groups, wherein the polymeric compound has a weight average molecular weight of 1,500 to 18,000 Daltons; and wherein a test article having a thickness of 3.2 mm and molded from the thermoplastic composition retains more ductility after aging at 134° C. and 100% humidity for 48 hours than an article having a thickness of 3.2 mm and molded from the same thermoplastic composition without the polymeric compound comprising at least two epoxy groups.

In another embodiment, a thermoplastic composition comprises a polymer component comprising a polyestercarbonate copolymer comprising ester units derived from the reaction of a mixture of isophthalic and terephthalic acid or a chemical equivalent thereof with a dihydroxy aromatic compound of the formula

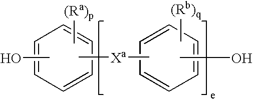

wherein each R^{a} and R^{b} is independently the same or different halogen or C₁₋₁₂ alkyl group; e is 0 or 1; and p and q are each independently integers of 0 to 4, or a chemical equivalent thereof, and carbonate units derived from a dihydroxy aromatic compound of the formula

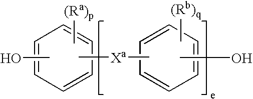

wherein each R^{a} and R^{b} is independently the same or different halogen or C₁₋₁₂ alkyl group; e is 0 or 1; and p and q are each independently integers of 0 to 4, wherein the molar ratio of ester units to carbonate units is 10:90 to 90:10; and 0.01 to 2 wt. %, based on the total weight of the polymer component, of a polymeric compound comprising at least two epoxy groups, wherein the polymeric compound has a weight average molecular weight of 3,000 to 13,000 Daltons.

In yet another embodiment, a thermoplastic composition comprises a polymer component comprising a polyestercarbonate copolymer comprising ester units derived from the reaction of a mixture of isophthalic and terephthalic acid or a chemical equivalent thereof with bisphenol A or a chemical equivalent thereof, and carbonate units derived from bisphenol A; wherein the molar ratio of ester units to carbonate units is 20:80 to 80:20; and 0.01 to 1 wt. %, based on the total weight of the polymer component, of a styrene-(meth)acrylate polymer with glycidyl side chains, wherein the polymeric compound has a weight average molecular weight of 4,000 to 8,500 Daltons.

In another embodiment, a method of manufacture of the above-described composition comprises blending the components of the composition; and extruding the blend.

In yet another embodiment, an article comprising the above-described thermoplastic composition is disclosed.

In still another embodiment, a method of manufacturing an article comprises shaping, molding, or forming the above-described thermoplastic composition into an article.

The above described and other features are exemplified by the following figures and detailed description.

### BRIEF DESCRIPTION OF THE FIGURES

FIG. 1 is a photomicrograph (8.1×) of a disk molded from Comparative Example A after heat aging for 24 hours at 134° C., 100% relative humidity in an autoclave.

FIG. 2 is a photomicrograph (8.1×) of a disk molded from Example 1 after heat aging for 24 hours at 134° C., 100% relative humidity in an autoclave.

FIG. 3 is a photomicrograph (8.1×) of a disk molded from Comparative Example B after heat aging for 24 hours at 134° C., 100% relative humidity in an autoclave.

FIG. 4 is a photomicrograph (8.1×) of a disk molded from Example 2 after heat aging for 24 hours at 134° C., 100% relative humidity in an autoclave.

FIG. 5 is an edge-wise photograph of a disk molded from Example 8 after 72 hours in an autoclave at 134° C.

FIG. 6 is an edge-wise photograph of a disk molded from Comparative Example D after 72 hours in an autoclave at 134° C.

### DETAILED DESCRIPTION OF THE INVENTION

Surprisingly, it has now been found that the hydrothermal stability of certain polyestercarbonate copolymer compositions is improved by the incorporation of a multifunctional epoxy compound. The compositions can further comprise a polycarbonate polymer. Such compositions have similar heat deformation temperatures as the same compositions without the multifunctional epoxy compound. In addition, the compositions can better retain their transparency after hydrolytic aging. In addition, the presence of the multifunctional epoxy compound in the polyestercarbonate copolymer compositions does not significantly adversely affect other desirable properties of the compositions, such as impact strength and dimensional stability. Because these compositions have a combination of good heat stability (heat distortion temperatures of greater than 130° C.) and improved hydrostability, they are useful for medical applications that require high temperature sterilization, e.g., in an autoclave.

Polycarbonate polymers and polyestercarbonate copolymers (which are also known as polyester carbonates, copolyester-polycarbonates, and copolycarbonate-esters) contain repeating carbonate units of the formula (1):

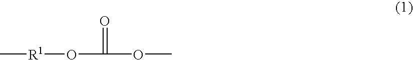

in which at least about 60 percent of the total number of R¹ groups contain aromatic organic groups and the balance thereof are aliphatic or alicyclic, or aromatic groups. As used herein, “polyestercarbonate copolymers” means a polymer containing both carbonate units of formula (1) and ester units as set forth below.

In an embodiment, each R¹ in the carbonate units is a C₆₋₃₀ aromatic group, that is, contains at least one aromatic moiety. R¹ can be derived from a dihydroxy compound of formula (2):

HO-A¹-Y¹-A²-OH (2)

wherein each of A¹ and A² is a monocyclic divalent aromatic group and Y¹ is a single bond or a bridging group having one or more atoms that separate A¹ from A². In an exemplary embodiment, one atom separates A¹ from A². Specifically, each R¹ can be derived from a dihydroxy aromatic compound of formula (3):

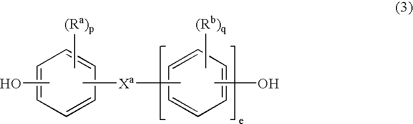

wherein R^{a} and R^{b} each represent a halogen or C₁₋₁₂ alkyl group and can be the same or different; e is 0 or 1; and p and q are each independently integers of 0 to 4. It will be understood that R^{a} is hydrogen when p is 0, and likewise R^{b} is hydrogen when q is 0. Also in formula (3), X^{a} represents a bridging group connecting the two hydroxy-substituted aromatic groups, where the bridging group and the hydroxy substituent of each C₆ arylene group are disposed ortho, meta, or para (specifically para) to each other on the C₆ arylene group. In an embodiment, the bridging group X^{a} is single bond, —O—, —S—, —S(O)—, —S(O)₂—, —C(O)—, or a C₁₋₁₈ organic group. The C₁₋₁₈ organic bridging group can be cyclic or acyclic, aromatic or non-aromatic, and can further comprise heteroatoms such as halogens, oxygen, nitrogen, sulfur, silicon, or phosphorous. The C₁₋₁₈ organic group can be disposed such that the C₆ arylene groups connected thereto are each connected to a common alkylidene carbon or to different carbons of the C₁₋₁₈ organic bridging group. In one embodiment, R^{a} and R^{b} are each a C₁₋₃ alkyl group, specifically methyl, disposed meta to the hydroxy group on each arylene group.

In an embodiment, X^{a} is a substituted or unsubstituted C₃₋₁₈ cycloalkylidene, a C₁₋₂₅ alkylidene of formula —C(R^{c})(R_{d})— wherein R^{c} and R^{d} are each independently hydrogen, C₁₋₁₂ alkyl, C₁₋₁₂ cycloalkyl, C₇₋₁₂ arylalkyl, C₁₋₁₂ heteroalkyl, or cyclic C₇₋₁₂ heteroarylalkyl, or a group of the formula —C(═R^{e})— wherein R^{e} is a divalent C₁₋₁₂ hydrocarbon group. Exemplary groups of this type include methylene, cyclohexylmethylene, ethylidene, neopentylidene, and isopropylidene, as well as 2-[2.2.1]-bicycloheptylidene, cyclohexylidene, cyclopentylidene, cyclododecylidene, and adamantylidene. A specific example wherein X^{a} is a substituted cycloalkylidene is the cyclohexylidene-bridged, alkyl-substituted bisphenol of formula (4):

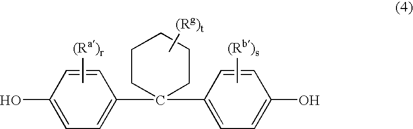

wherein R^{a′} and R^{b′} are each independently C₁₋₁₂ alkyl, R^{g} is C₁₋₁₂ alkyl or halogen, r and s are each independently 1 to 4, and t is 0 to 10. In a specific embodiment, at least one of each of R^{a′} and R^{b′} are disposed meta to the cyclohexylidene bridging group. The substituents R^{a′}, R^{b′}, and R^{g} may, when comprising an appropriate number of carbon atoms, be straight chain, cyclic, bicyclic, branched, saturated, or unsaturated. In an embodiment, R^{a′} and R^{b′} are each independently C₁₋₄ alkyl, R^{g} is C₁₋₄ alkyl, r and s are each 1, and t is 0 to 5. In another specific embodiment, R^{a′}, R_{b′} and R^{g} are each methyl, r and s are each 1, and t is 0 or 3. The cyclohexylidene-bridged bisphenol can be the reaction product of two moles of o-cresol with one mole of cyclohexanone. In another exemplary embodiment, the cyclohexylidene-bridged bisphenol is the reaction product of two moles of a cresol with one mole of a hydrogenated isophorone (e.g., 1,1,3-trimethyl-3-cyclohexane-5-one). Such cyclohexane-containing bisphenols, for example the reaction product of two moles of a phenol with one mole of a hydrogenated isophorone, are useful for making polycarbonate polymers with high glass transition temperatures and high heat distortion temperatures. Cyclohexyl bisphenol-containing polycarbonates, or a combination comprising at least one of the foregoing with other bisphenol polycarbonates, are supplied by Bayer Co. under the APEC® trade name.

In another embodiment, X^{a} is a C₁₋₁₈ alkylene group, a C₃₋₁₈ cycloalkylene group, a fused C₆₋₁₈ cycloalkylene group, or a group of the formula —B¹—W—B²— wherein B¹ and B² are the same or different C₁₋₆ alkylene group and W is a C₃₋₁₂ cycloalkylidene group or a C₆₋₁₆ arylene group.

In another embodiment, X^{a} is a substituted C₃₋₁₈ cycloalkylidene of the formula (5):

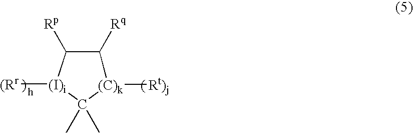

wherein R^{r}, R^{p}, R^{q}, and R^{t} are independently hydrogen, halogen, oxygen, or C₁₋₁₂ organic groups; I is a direct bond, a carbon, or a divalent oxygen, sulfur, or —N(Z)- where Z is hydrogen, halogen, hydroxy, C₁₋₁₂ alkyl, C₁₋₁₂ alkoxy, C₆₋₁₂ aryl, or C₁₋₁₂ acyl; h is 0 to 2, j is 1 or 2, i is an integer of 0 or 1, and k is an integer of 0 to 3, with the proviso that at least two of R^{r}, R^{p}, R^{q}, and R^{t} taken together are a fused cycloaliphatic, aromatic, or heteroaromatic ring. It will be understood that where the fused ring is aromatic, the ring as shown in formula (5) will have an unsaturated carbon-carbon linkage where the ring is fused. When i is 0, h is 0, and k is 1, the ring as shown in formula (5) contains 4 carbon atoms; when i is 0, h is 0, and k is 2, the ring as shown contains 5 carbon atoms, and when i is 0, h is 0, and k is 3, the ring contains 6 carbon atoms. In one embodiment, two adjacent groups (e.g., R^{q} and R^{t} taken together) form an aromatic group, and in another embodiment, R^{q} and R^{t} taken together form one aromatic group and R^{r} and R^{p} taken together form a second aromatic group. When R^{q} and R^{t} taken together form an aromatic group, R^{p} can be a double-bonded oxygen atom, i.e., a ketone.

Some illustrative, non-limiting examples of bisphenol-type dihydroxy aromatic compounds include the following: 4,4′-dihydroxybiphenyl, 1,6-dihydroxynaphthalene, 2,6-dihydroxynaphthalene, bis(4-hydroxyphenyl)methane, bis(4-hydroxyphenyl)diphenylmethane, bis(4-hydroxyphenyl)-1-naphthylmethane, 1,2-bis(4-hydroxyphenyl)ethane, 1,1-bis(4-hydroxyphenyl)-1-phenylethane, 2-(4-hydroxyphenyl)-2-(3-hydroxyphenyl)propane, bis(4-hydroxyphenyl)phenylmethane, 2,2-bis(4-hydroxy-3-bromophenyl)propane, 1,1-bis(hydroxyphenyl)cyclopentane, 1,1-bis(4-hydroxyphenyl)cyclohexane, 1,1-bis(4-hydroxy-3 methyl phenyl)cyclohexane 1,1-bis(4-hydroxyphenyl)isobutene, 1,1-bis(4-hydroxyphenyl)cyclododecane, trans-2,3-bis(4-hydroxyphenyl)-2-butene, 2,2-bis(4-hydroxyphenyl)adamantine, (alpha, alpha′-bis(4-hydroxyphenyl)toluene, bis(4-hydroxyphenyl)acetonitrile, 2,2-bis(3-methyl-4-hydroxyphenyl)propane, 2,2-bis(3-ethyl-4-hydroxyphenyl)propane, 2,2-bis(3-n-propyl-4-hydroxyphenyl)propane, 2,2-bis(3-isopropyl-4-hydroxyphenyl)propane, 2,2-bis(3-sec-butyl-4-hydroxyphenyl)propane, 2,2-bis(3-t-butyl-4-hydroxyphenyl)propane, 2,2-bis(3-cyclohexyl-4-hydroxyphenyl)propane, 2,2-bis(3-allyl-4-hydroxyphenyl)propane, 2,2-bis(3-methoxy-4-hydroxyphenyl)propane, 2,2-bis(4-hydroxyphenyl)hexafluoropropane, 1,1-dichloro-2,2-bis(4-hydroxyphenyl)ethylene, 1,1-dibromo-2,2-bis(4-hydroxyphenyl)ethylene, 1,1-dichloro-2,2-bis(5-phenoxy-4-hydroxyphenyl)ethylene, 4,4′-dihydroxybenzophenone, 3,3-bis(4-hydroxyphenyl)-2-butanone, 1,6-bis(4-hydroxyphenyl)-1,6-hexanedione, ethylene glycol bis(4-hydroxyphenyl)ether, bis(4-hydroxyphenyl)ether, bis(4-hydroxyphenyl)sulfide, bis(4-hydroxyphenyl)sulfoxide, bis(4-hydroxyphenyl)sulfone, 9,9-bis(4-hydroxyphenyl)fluorene, 2,7-dihydroxypyrene, 6,6′-dihydroxy-3,3,3′,3′-tetramethylspiro(bis)indane (“spirobiindane bisphenol”), 3,3-bis(4-hydroxyphenyl)phthalide, 2,6-dihydroxydibenzo-p-dioxin, 2,6-dihydroxythianthrene, 2,7-dihydroxyphenoxathin, 2,7-dihydroxy-9,10-dimethylphenazine, 3,6-dihydroxydibenzofuran, 3,6-dihydroxydibenzothiophene, and 2,7-dihydroxycarbazole, and the like, as well as combinations comprising at least one of the foregoing dihydroxy aromatic compounds.

Specific examples of the types of bisphenol compounds represented by formula (3) include 1,1-bis(4-hydroxyphenyl)methane, 1,1-bis(4-hydroxyphenyl)ethane, 2,2-bis(4-hydroxyphenyl)propane (hereinafter “bisphenol A” or “BPA”), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, 2,2-bis(4-hydroxy-1-methylphenyl)propane, 1,1-bis(4-hydroxy-t-butylphenyl)propane, 3,3-bis(4-hydroxyphenyl)phthalimidine, 2-phenyl-3,3-bis(4-hydroxyphenyl)phthalimidine (“PBPP”), 9,9-bis(4-hydroxyphenyl)fluorene, and 1,1-bis(4-hydroxy-3-methylphenyl)cyclohexane (“DMBPC”). Combinations comprising at least one of the foregoing dihydroxy aromatic compounds can also be used.

Specific exemplary polyestercarbonate copolymers contain carbonate units derived from bisphenol A. A specific exemplary polycarbonate is a homopolymer that contains units derived from bisphenol A. A polycarbonate can also be used that contains units derived from a mixture of bisphenol A and PBPP, in a molar ratio of BPA:PBPP of 10:90 to 90:10, specifically 15:85 to 85:15.

The polyestercarbonate copolymers contain ester blocks in addition to the carbonate blocks described above. The ester blocks contain repeating ester units of formula (6):

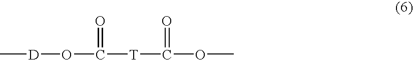

wherein each D or T can be the same or different and is independently a divalent group derived from a dihydroxy compound or a chemical equivalent thereof, and can be, for example, a C₆₋₃₀ aromatic group.

In an embodiment, D is derived from a dihydroxy aromatic compound of formula (2), specifically bisphenol A, formula (3), formula (4), or a combination comprising at least one of the foregoing dihydroxy aromatic compounds.

Examples of aromatic dicarboxylic acids from which the T group in the ester unit of formula (6) is derived include isophthalic or terephthalic acid, 1,2-di(p-carboxyphenyl)ethane, 4,4′-dicarboxydiphenyl ether, 4,4′-bisbenzoic acid, and combinations comprising at least one of the foregoing acids. Acids containing fused rings can also be present, such as in 1,4-, 1,5-, or 2,6-naphthalenedicarboxylic acids. Specific dicarboxylic acids are terephthalic acid, isophthalic acid, naphthalene dicarboxylic acid, or combinations thereof.

In a specific embodiment, the ester units are derived from isophthalic acid, terephthalic acid, or a combination thereof, wherein the weight ratio of isophthalic acid to terephthalic acid is 99:1 to 1:99, specifically 99:1 to 50:50, more specifically 99:1 to 80:20. A specific aromatic polyester unit is a poly(isophthalate-terephthalate-bisphenol A) ester unit.

The polyestercarbonate copolymer can have alternating ester units and carbonate units, or blocks of ester units and blocks of carbonate units. When present, the polyester blocks and polycarbonate blocks can be of varying sizes. In general the units are present as blocks of 5 to 500, specifically 10 to 300, and more specifically 15 to 200 ester or carbonate units. The molar ratio of ester units to carbonate units can be 99:1 to 1:99, specifically 95:5 to 5:95, or more specifically 90:10 to 10:90.

The polyestercarbonate copolymer can have a weight average molecular weight (Mw) of 2,000 to 100,000 g/mol, specifically 3,000 to 75,000 g/mol, more specifically 4,000 to 50,000 g/mol, even more specifically 5,000 to 45,000 g/mol, or still more specifically 7,000 to 40,000 g/mol. Molecular weight determinations are performed using gel permeation chromatography (GPC) using a crosslinked styrene-divinyl benzene column, at a sample concentration of 1 milligram per milliliter, and as calibrated with polycarbonate standards. Samples are eluted at a flow rate of 1.0 ml/min.

The polyestercarbonate copolymer can be present in the amount of 5 to 99.99 wt. %, specifically 10 to 99.9 wt. %, or more specifically 20 to 99 wt. %, based on the total weight of the thermoplastic composition.

The thermoplastic compositions can further comprise a polycarbonate in addition to the polyestercarbonate copolymer. As used herein, “polycarbonate” refers to polymers containing only carbonate units of formula (1) as the repeating units. The polycarbonates can be homopolymers, or copolycarbonates, that is, polymers containing more than one type of carbonate units. The copolycarbonates can have alternating sequences of different carbonate units, random sequences of different carbonate units, or a combination of these structural arrangements of different carbonate units. Where blocks are used, the block length can generally be 2 to 1,000 repeating units.

The polycarbonates can have an Mw of 2,000 to 200,000 g/mol, specifically 5,000 to 150,000 g/mol, more specifically 10,000 to 100,000 g/mol, more specifically 15,000 to 75,000 g/mol, and still more specifically 17,000 to 50,000 g/mol. Molecular weight determinations are performed using gel permeation chromatography (GPC) using a crosslinked styrene-divinyl benzene column, at a sample concentration of 1 milligram per milliliter, and as calibrated with polystyrene standards. Samples are eluted at a flow rate of 1.0 ml/min.

An exemplary polycarbonate for use in the thermoplastic compositions includes homopolycarbonates derived from bisphenol A. The polycarbonates can further comprise units derived from another bisphenol, such as DMBPC. The molar ratio of bisphenol A carbonate units to DMBPC carbonate units can be 1:99 to 99:1, specifically 5:95 to 90:10, and more specifically 10:90 to 80:20.

The polycarbonates and polyestercarbonate copolymers can be manufactured by different polymerization methods such as solution polymerization, interfacial polymerization, and melt polymerization. Of these, a specifically useful method is interfacial polymerization. Although the reaction conditions for interfacial polymerization can vary, a process generally involves dissolving or dispersing a dihydric phenol reactant in aqueous caustic soda or potash, adding the resulting mixture to a water-immiscible solvent medium, and contacting the reactants with a carbonate precursor in the presence of a catalyst such as, for example, triethylamine or a phase transfer catalyst, under controlled pH conditions, e.g., 8 to 11.5. The most commonly used water immiscible solvents include methylene chloride, 1,2-dichloroethane, chlorobenzene, toluene, and the like. Exemplary carbonate precursors include, for example, a carbonyl halide such as carbonyl bromide or carbonyl chloride, or a haloformate such as a bishaloformates of a dihydric phenol (e.g., the bischloroformates of bisphenol A, hydroquinone, or the like) or a glycol (e.g., the bishaloformate of ethylene glycol, neopentyl glycol, polyethylene glycol, or the like). Combinations comprising at least one of the foregoing types of carbonate precursors can also be used. In an exemplary embodiment, an interfacial polymerization reaction to form carbonate linkages uses phosgene as a carbonate precursor, and is referred to as a phosgenation reaction.

A chain stopper (also referred to as a capping agent) can be included during polymerization. The chain stopper limits molecular weight growth rate, and so controls molecular weight in the polycarbonate or the polyestercarbonate. A chain stopper can be at least one of mono-phenolic compounds, mono-carboxylic acid chlorides, and/or mono-chloroformates. Where a chain stopper is incorporated with the polycarbonate or the polyestercarbonate, the chain stopper can also be referred to as an end group.

For example, mono-phenolic compounds useful as chain stoppers include monocyclic phenols, such as phenol, C₁-C₂₂ alkyl-substituted phenols, p-cumyl-phenol, p-tertiary-butyl phenol, hydroxy diphenyl; monoethers of diphenols, such as p-methoxyphenol. Alkyl-substituted phenols include those with branched chain alkyl substituents having 8 to 9 carbon atoms. A mono-phenolic UV absorber can be used as capping agent. Such compounds include 4-substituted-2-hydroxybenzophenones and their derivatives, aryl salicylates, monoesters of diphenols such as resorcinol monobenzoate, 2-(2-hydroxyaryl)-benzotriazoles and their derivatives, 2-(2-hydroxyaryl)-1,3,5-triazines and their derivatives, and the like. Specifically, mono-phenolic chain stoppers include phenol, p-cumylphenol, and/or resorcinol monobenzoate.

Mono-carboxylic acid chlorides can also be useful as chain stoppers. These include monocyclic, mono-carboxylic acid chlorides such as benzoyl chloride, C₁-C₂₂ alkyl-substituted benzoyl chloride, 4-methylbenzoyl chloride, halogen-substituted benzoyl chloride, bromobenzoyl chloride, cinnamoyl chloride, 4-nadimidobenzoyl chloride, and combinations thereof; polycyclic, mono-carboxylic acid chlorides such as trimellitic anhydride chloride, and naphthoyl chloride; and combinations of monocyclic and polycyclic mono-carboxylic acid chlorides. Chlorides of aliphatic monocarboxylic acids with up to 22 carbon atoms are useful. Functionalized chlorides of aliphatic monocarboxylic acids, such as acryloyl chloride and methacryoyl chloride, are also useful. Also useful are mono-chloroformates including monocyclic, mono-chloroformates, such as phenyl chloroformate, alkyl-substituted phenyl chloroformate, p-cumyl phenyl chloroformate, toluene chloroformate, and combinations thereof.

Among the phase transfer catalysts that can be used in interfacial polymerization are catalysts of the formula (R³)₄Q⁺X, wherein each R³ is the same or different, and is a C₁₋₁₀ alkyl group; Q is a nitrogen or phosphorus atom; and X is a halogen atom or a C₁₋₈ alkoxy group or C₆₋₁₈ aryloxy group. Exemplary phase transfer catalysts include, for example, [CH₃(CH₂)₃]₄NX, [CH₃(CH₂)₃]₄PX, [CH₃(CH₂)₅]₄NX, [CH₃(CH₂)₆]₄NX, [CH₃(CH₂)₄]₄NX, CH₃[CH₃(CH₂)₃]₃NX, and CH₃[CH₃(CH₂)₂]₃NX, wherein X is Cl⁻, Br⁻, a C₁₋₈ alkoxy group or a C₆₋₁₈ aryloxy group. In an embodiment, a specifically useful phase transfer catalyst is CH₃[CH₃(CH₂)₃]₃NCl (methyl tri-n-butyl ammonium chloride). An effective amount of a phase transfer catalyst can be 0.1 to 10 wt. % based on the weight of bisphenol in the phosgenation mixture. In another embodiment an effective amount of phase transfer catalyst can be 0.5 to 2 wt. % based on the weight of dihydroxy aromatic compound in the phosgenation mixture.

Polyestercarbonate copolymers can also be prepared by interfacial polymerization. Typically, a reactive derivative of the desired aromatic or aliphatic dicarboxylic acid is used. In one embodiment, the dicarboxylic acid dihalide is used, in particular dicarboxylic acid dichlorides and dicarboxylic acid dibromides, which are condensed under interfacial polymerization conditions as described above (biphasic solvent, pH of 4 to 11, and addition of base to maintain a desired pH) with dihydroxy aromatic compounds in a pre-carbonate condensation to form the polyester units. In an exemplary embodiment, instead of using isophthalic acid, terephthalic acid, or combinations thereof, it is possible and even desirable to employ isophthaloyl dichloride, terephthaloyl dichloride, and combinations thereof in the preparation of polyesters having arylate ester units. After interfacial polymerization to condense the dicarboxylic acid derivative and dihydroxy aromatic compound, sometimes referred to as polyester oligomerization, the resulting polyester polymer or oligomer is co-condensed with a dihydroxy aromatic compound under interfacial polycarbonate reaction conditions to form the polyester-polycarbonate. In an exemplary embodiment, a dihydroxy aromatic compound of formula (2), (3), or (4) is used in either or both of the polyester oligomerization or the interfacial polycarbonate reaction.

Alternatively, melt processes can be used to make the polycarbonates and the polyestercarbonate copolymers. Generally, in the melt polymerization process, polycarbonates can be prepared by co-reacting, in a molten state, the dihydroxy reactant(s) and a diaryl carbonate ester, such as diphenyl carbonate, in the presence of a transesterification catalyst in a Banbury® mixer, single or twin screw extruder, or the like to form a uniform dispersion. Volatile monohydric phenol is removed from the molten reactants by distillation and the polymer is isolated as a molten residue. A specifically useful melt process for making polycarbonates uses a diaryl carbonate ester having electron-withdrawing substituents on the aryls. Examples of specifically useful diaryl carbonate esters with electron withdrawing substituents include bis(4-nitrophenyl)carbonate, bis(2-chlorophenyl)carbonate, bis(4-chlorophenyl)carbonate, bis(methyl salicyl)carbonate, bis(4-methylcarboxylphenyl)carbonate, bis(2-acetylphenyl)carboxylate, bis(4-acetylphenyl)carboxylate, or a combination comprising at least one of the foregoing. In addition, exemplary transesterification catalysts can include phase transfer catalysts of formula (R³)₄Q⁺X above, wherein each R³, Q, and X are as defined above. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

Exemplary transesterification catalysts can include phase transfer catalysts of formula (R³)₄Q⁺X above, wherein each R³, Q, and X is as defined above. Examples of such transesterification catalysts include tetrabutylammonium hydroxide, methyltributylammonium hydroxide, tetrabutylammonium acetate, tetrabutylphosphonium hydroxide, tetrabutylphosphonium acetate, tetrabutylphosphonium phenolate, or a combination comprising at least one of the foregoing.

The multifunctional epoxy compound for improving the hydrolytic stability of the thermoplastic compositions can be either polymeric or non-polymeric. As used herein, the term “multifunctional” means that at least two epoxy groups are present in each molecule of the epoxy compound. Other functional groups can also be present, provided that such groups do not substantially adversely affect the desired properties of the thermoplastic composition.

The multifunctional epoxy compound can contain aromatic and/or aliphatic residues, as well as non-epoxy functional groups. In one embodiment, the multifunctional epoxy compound is a polymeric compound comprising at least two epoxy groups, wherein the polymeric compound has an Mw of 15,000 to 18,000. Exemplary polymers (which as used herein includes oligomers) having multiple epoxy groups include the reaction products of an epoxy-containing ethylenically unsaturated monomer (e.g., a glycidyl(C₁₋₄ alkyl)(meth)acrylate, allyl glycidyl ethacrylate, and glycidyl itoconate) with one or more non-epoxy functional ethylenically unsaturated compounds (e.g., styrene, ethylene, methyl(meth)acrylate, n-butyl acrylate, and the like). As used herein, the term “(meth)acrylic acid” includes both acrylic and methacrylic acid monomers, and the term “(meth)acrylate” includes both acrylate and methacrylate monomers. Specifically, the multifunctional epoxy polymer can be the reaction product of an epoxy-functional (meth)acrylate monomer with a non-epoxy functional styrenic and/or (C₁₋₈ hydrocarbyl)(meth)acrylate and/or olefin and/or vinyl acetate monomer.

In one embodiment the multifunctional epoxy polymer is a copolymeric reaction product of a glycidyl(meth)acrylate monomer, ethylene, and optionally a C₁₋₄(alkyl)(meth)acrylate monomer. Useful commercially available terpolymers of this type include the ethylene-methyl acrylate-glycidyl methacrylate terpolymers sold under the trade name LOTADER by Atofina. Also available is a LOTADER grade with maleic anhydride.

In another embodiment the multifunctional epoxy polymer is the reaction product of an epoxy-functional (meth)acrylate monomer, a non-epoxy functional styrenic monomer, and optionally a non-epoxy functional C₁₋₈(hydrocarbyl)(meth)acrylate monomer. Examples of specific epoxy-functional (meth)acrylate monomers include those containing 1,2-epoxy groups such as glycidyl acrylate and glycidyl methacrylate. Exemplary styrenic monomers include styrene, alpha-methyl styrene, vinyl toluene, p-methyl styrene, t-butyl styrene, o-chlorostyrene, and mixtures comprising at least one of the foregoing. In certain embodiments the styrenic monomer is styrene and/or alpha-methyl styrene. Exemplary C₁₋₈(hydrocarbyl)(meth)acrylate monomers include methyl acrylate, ethyl acrylate, n-propyl acrylate, i-propyl acrylate, n-butyl acrylate, s-butyl acrylate, i-butyl acrylate, t-butyl acrylate, n-amyl acrylate, i-amyl acrylate, isobornyl acrylate, n-hexyl acrylate, 2-ethylbutyl acrylate, 2-ethylhexyl acrylate, n-octyl acrylate, n-decyl acrylate, methylcyclohexyl acrylate, cyclopentyl acrylate, cyclohexyl acrylate, methyl methacrylate, ethyl methacrylate, n-propyl methacrylate, n-butyl methacrylate, i-propyl methacrylate, i-butyl methacrylate, n-amyl methacrylate, n-hexyl methacrylate, i-amyl methacrylate, s-butyl-methacrylate, t-butyl methacrylate, 2-ethylbutyl methacrylate, methylcyclohexyl methacrylate, cinnamyl methacrylate, crotyl methacrylate, cyclohexyl methacrylate, cyclopentyl methacrylate, 2-ethoxyethyl methacrylate, and isobornyl methacrylate. Specific optional commoners are C₁₋₄(alkyl)(meth)acrylate monomers. Combinations comprising at least one of the foregoing comonomers can be used.

Several useful examples of styrene-(meth)acrylate copolymers containing glycidyl groups incorporated as side chains are described in the International Patent Application WO 03/066704 A1, assigned to Johnson Polymer, LLC (now BASF), which is incorporated herein by reference in its entirety. A high number of epoxy groups per mole is useful, for example, 10 to 500, more specifically 100 to 400, or even more specifically 250 to 350. These polymeric materials have a weight average molecular weight of 1500 to 18,000, specifically 3,000 to 13,000, or even more specifically 4,000 to 8,500 Daltons. Epoxy-functional styrene-(meth)acrylate copolymers with glycidyl groups are commercially available from Johnson Polymer, LLC (now BASF) under the Joncryl® trade name, for example the Joncryl® ADR 4368 material.

In another embodiment, the multifunctional epoxy compound is a monomeric or polymeric compound having two terminal epoxy functionalities, and optionally or other functionalities. The compound can further contain only carbon, hydrogen, and oxygen. Difunctional epoxy compounds, in particular those containing only carbon, hydrogen, and oxygen can have a molecular weight of below 1000 g/mol. In one embodiment the difunctional epoxy compounds have at least one of the epoxide groups on a cyclohexane ring. Exemplary difunctional epoxy compounds include, but are not limited to, 3,4-epoxycyclohexyl-3,4-epoxycyclohexyl carboxylate, bis(3,4-epoxycyclohexylmethyl)adipate, and vinylcyclohexene di-epoxide, bisphenol diglycidyl ethers such as bisphenol A diglycidyl ether (available from Dow Chemical Company under the trade names DER 332, DER 661, and DER 667, or from Hexion under the trade names EPON 826, EPON 828, EPON 1001F, EPON 1004F, EPON 1005F, EPON 1007F, and EPON 1009F), tetrabromobisphenol A diglycidyl ether, glycidol, diglycidyl adducts of amines and amides, diglycidyl adducts of carboxylic acids such as the diglycidyl ester of phthalic acid and the diglycidyl ester of hexahydrophthalic acid (available from Ciba Products under the trade name Araldite CY 182), bis(3,4-epoxy-6-methylcyclohexylmethyl)adipate, butadiene diepoxide, vinylcyclohexene diepoxide, dicyclopentadiene diepoxide, cycloaliphatic epoxy resins commercially available from Dow under the trade names, ERL-4221 and ERL-4299, and the like. Especially useful is 3,4-epoxycyclohexyl-3,4epoxycyclohexylcarboxylate, commercially available from Union Carbide Corporation.

The epoxy compound is added to the thermoplastic composition in an amount effective to aid in the retention of transparency, dimensional integrity, and/or impact strength of the composition after hydrothermal aging. In one embodiment, the epoxy compound is added to the thermoplastic composition in an amount effective to retain the transparency of the composition after hydrothermal treatment. In another embodiment, the epoxy compound is added to the thermoplastic composition in an amount effective to improve the retention of impact strength of the composition after hydrothermal aging. In another embodiment, the epoxy compound is added to the thermoplastic composition in an amount effective to improve the retention of dimensional integrity of the composition after hydrothermal aging. A person skilled in the art can determine the optimum type and amount of any given epoxy compound without undue experimentation, using the guidelines provided herein. The type and amount of the epoxy compound will depend on the desired characteristics of the composition, the type of polycarbonate-containing copolymer used, the type and amount of other additives present in the composition and like considerations. For example, the amount of the epoxy compound is 0.01 to 10 wt. %, more specifically, 0.01 to 2 wt. %, or even more specifically, 0.05 to 1 wt. %, based on the total weight of the polymer component of the thermoplastic composition.

A wide variety of additives can be used in the thermoplastic compositions, with the proviso that the additive(s) and amount(s) are selected such that their inclusion does not significantly adversely affect the desired properties of the thermoplastic composition, for example, transparency, hydrolytic stability, or mechanical properties such as for example the impact properties. Such additives can be included during the mixing of the components to form the thermoplastic composition. Thus, in an embodiment, the thermoplastic composition can further comprise an additive including an impact modifier, a filler, an ionizing radiation stabilizer, an antioxidant, a heat stabilizer, a light stabilizer, an ultraviolet light absorber, a plasticizer, a lubricant, a mold release agent, an antistatic agent, a pigment, a dye, a flame retardant, an anti-drip agent, or a combination comprising at least one of the foregoing additives.

Suitable impact modifiers are typically high molecular weight elastomeric materials derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of impact modifiers can be used.

A specific type of impact modifier is an elastomer-modified graft copolymer comprising (i) an elastomeric (i.e., rubbery) polymer substrate having a Tg less than about 10° C., more specifically less than about −10° C., or more specifically about −400 to −80° C., and (ii) a rigid polymeric superstrate grafted to the elastomeric polymer substrate. Materials suitable for use as the elastomeric phase include, for example, conjugated diene rubbers, for example polybutadiene and polyisoprene; copolymers of a conjugated diene with less than about 50 wt. % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl(meth)acrylates; elastomeric copolymers of C₁₋₈ alkyl(meth)acrylates with butadiene and/or styrene; or combinations comprising at least one of the foregoing elastomers. Materials suitable for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate. Specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN). Impact modifiers are generally present in amounts of 1 to 30 wt. %, based on the total weight of the polymers in the composition.

The thermoplastic compositions can comprise a colorant such as a pigment and/or dye additive. Useful pigments include for example, inorganic pigments such as metal oxides and mixed metal oxides such as zinc oxide, titanium dioxides, iron oxides or the like; sulfides such as zinc sulfides, or the like; aluminates; sodium sulfo-silicates, sulfates, chromates, or the like; carbon blacks; zinc ferrites; ultramarine blue; organic pigments such as azos, di-azos, quinacridones, perylenes, naphthalene tetracarboxylic acids, flavanthrones, isoindolinones, tetrachloroisoindolinones, anthraquinones, anthrones, dioxazines, phthalocyanines, and azo lakes; Pigment Brown 24, Pigment Red 101, Pigment Red 122, Pigment Red 149, Pigment Red 177, Pigment Red 179, Pigment Red 202, Pigment Violet 29, Pigment Blue 15, Pigment Blue 15:4, Pigment Blue 28, Pigment Blue 60, Pigment Green 7, Pigment Yellow 119, Pigment Yellow 147, or Pigment Yellow 150; or combinations comprising at least one of the foregoing pigments. Pigments can be used in amounts of 0.01 to 10 wt. % of the total weight of the thermoplastic composition (excluding any filler).

Useful dyes can be organic materials and include, for example, coumarin dyes such as coumarin 460 (blue), coumarin 6 (green), nile red or the like; lanthanide complexes; hydrocarbon and substituted hydrocarbon dyes; polycyclic aromatic hydrocarbon dyes; scintillation dyes such as oxazole or oxadiazole dyes; aryl- or heteroaryl-substituted poly(C₂₋₈)olefin dyes; carbocyanine dyes; indanthrone dyes; phthalocyanine dyes; oxazine dyes; carbostyryl dyes; napthalenetetracarboxylic acid dyes; porphyrin dyes; bis(styryl)biphenyl dyes; acridine dyes; anthraquinone dyes; cyanine dyes; methine dyes; arylmethane dyes; azo dyes; indigoid dyes, thioindigoid dyes, diazonium dyes; nitro dyes; quinone imine dyes; aminoketone dyes; tetrazolium dyes; thiazole dyes; perylene dyes, perinone dyes; bis-benzoxazolylthiophene (BBOT); triarylmethane dyes; xanthene dyes; thioxanthene dyes; naphthalimide dyes; lactone dyes; fluorophores such as anti-stokes shift dyes which absorb in the near infrared wavelength and emit in the visible wavelength, or the like; luminescent dyes such as 7-amino-4-methylcoumarin; 3-(2′-benzothiazolyl)-7-diethylaminocoumarin; 2-(4-biphenylyl)-5-(4-t-butylphenyl)-1,3,4-oxadiazole; 2,5-bis-(4-biphenylyl)-oxazole; 2,2′-dimethyl-p-quaterphenyl; 2,2-dimethyl-p-terphenyl; 3,5,3″″,5″″-tetra-t-butyl-p-quinquephenyl; 2,5-diphenylfuran; 2,5-diphenyloxazole; 4,4′-diphenylstilbene; 4-dicyanomethylene-2-methyl-6-(p-dimethylaminostyryl)-4H-pyran; 1,1′-diethyl-2,2′-carbocyanine iodide; 3,3′-diethyl-4,4′,5,5′-dibenzothiatricarbocyanine iodide; 7-dimethylamino-1-methyl-4-methoxy-8-azaquinolone-2; 7-dimethylamino-4-methylquinolone-2; 2-(4-(4-dimethylaminophenyl)-1,3-butadienyl)-3-ethylbenzothiazolium perchlorate; 3-diethylamino-7-diethyliminophenoxazonium perchlorate; 2-(1-naphthyl)-5-phenyloxazole; 2,2′-p-phenylen-bis(5-phenyloxazole); rhodamine 700; rhodamine 800; pyrene; chrysene; rubrene; coronene, or the like, or combinations comprising at least one of the foregoing dyes. Where it is desirable to use organic dyes and pigments, the dyes can be screened to determine their sensitivity to gamma radiation at a given exposure dose or range of exposure doses. Dyes can be used in amounts of 0.01 to 10 wt. % of the total weight of the thermoplastic composition (excluding any filler).

The thermoplastic compositions can include fillers or reinforcing agents, although these are not generally used where transparent compositions are desired. The fillers and reinforcing agents can desirably be in the form of nanoparticles, i.e., particles with a median particle size (D₅₀) smaller than 100 nm as determined using light scattering methods. Where used, fillers or reinforcing agents include, for example, silicates and silica powders such as aluminum silicate (mullite), synthetic calcium silicate, zirconium silicate, fused silica, crystalline silica graphite, natural silica sand, or the like; boron powders such as boron-nitride powder, boron-silicate powders, or the like; oxides such as TiO₂, aluminum oxide, magnesium oxide, or the like; calcium sulfate (as its anhydride, dihydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres, silicate spheres, cenospheres, aluminosilicate (armospheres), or the like; kaolin, including hard kaolin, soft kaolin, calcined kaolin, kaolin comprising various coatings known in the art to facilitate compatibility with the polymeric matrix resin, or the like; single crystal fibers or “whiskers” such as silicon carbide, alumina, boron carbide, iron, nickel, copper, or the like; fibers (including continuous and chopped fibers) such as asbestos, carbon fibers, glass fibers, such as E, A, C, ECR, R, S, D, or NE glasses, or the like; sulfides such as molybdenum sulfide, zinc sulfide or the like; barium compounds such as barium titanate, barium ferrite, barium sulfate, heavy spar, or the like; metals and metal oxides such as particulate or fibrous aluminum, bronze, zinc, copper and nickel or the like; flaked fillers such as glass flakes, flaked silicon carbide, aluminum diboride, aluminum flakes, steel flakes or the like; fibrous fillers, for example short inorganic fibers such as those derived from blends comprising at least one of aluminum silicates, aluminum oxides, magnesium oxides, and calcium sulfate hemihydrate or the like; natural fillers and reinforcements, such as wood flour obtained by pulverizing wood, fibrous products such as cellulose, cotton, sisal, jute, starch, cork flour, lignin, ground nut shells, corn, rice grain husks or the like; organic fillers such as polytetrafluoroethylene; reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; as well as additional fillers and reinforcing agents such as mica, clay, feldspar, flue dust, fillite, quartz, quartzite, perlite, tripoli, diatomaceous earth, carbon black, or the like, or combinations comprising at least one of the foregoing fillers or reinforcing agents.

Useful fillers contemplated herein are visual effects fillers that possess compositional, shape and dimensional qualities suitable to the reflection and/or refraction of light. Visual effect fillers include those having planar facets and can be multifaceted or in the form of flakes, shards, plates, leaves, wafers, and the like. The shape can be irregular or regular, for example a hexagonal plate. Specifically useful visual effect fillers are two dimensional, plate-type fillers, wherein a particle of a plate type filler has a ratio of its largest dimension to smallest dimension of greater than or equal to 3:1, specifically greater than or equal to 5:1, and more specifically greater than or equal to 10:1. Specific reflective fillers are further of a composition having an optically dense surface exterior finish for reflecting incident light. Metallic and non-metallic fillers such as those based on aluminum, silver, copper, bronze, steel, brass, gold, tin, silicon, alloys of these, combinations comprising at least one of the foregoing metals, and the like, are specifically useful. Also useful are inorganic fillers prepared from a composition presenting a surface that reflects and/or refracts incident light. In contrast to a reflective filler, a refractive filler having refractive properties can be at least partially transparent, i.e., can allow transmission of a percentage of incident light, and can provide optical properties based on reflection, refraction, or a combination of reflection and refraction of incident light. Inorganic fillers having light reflecting and/or refracting properties can include micas, alumina, lamellar talc, silica, silicon carbide, glass, combinations comprising at least one of the foregoing inorganic fillers, and the like.

Fillers can be used in amounts of 0 to 90 parts by weight, based on 100 parts of the polymer components of the thermoplastic composition.

The thermoplastic composition can also include antioxidant additives, for example, organophosphites such as tris(2,6-di-tert-butylphenyl)phosphite (Irgafos I-168), tris(nonyl phenyl)phosphite, tris(2,4-di-t-butylphenyl)phosphite, bis(2,4-di-t-butylphenyl)pentaerythritol diphosphite, distearyl pentaerythritol diphosphite or the like; alkylated monophenols or polyphenols; alkylated reaction products of polyphenols with dienes, such as tetrakis[methylene(3,5-di-tert-butyl-4-hydroxyhydrocinnamate)]methane, or the like; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate or the like; amides of beta-(3,5-di-tert-butyl-4-hydroxyphenyl)-propionic acid or the like; or combinations comprising at least one of the foregoing antioxidants. An exemplary antioxidant is SANDOSTAB® P-EPQ phosphite stabilizer, commercially available from Clariant. Antioxidants can be used in amounts of 0.0001 to 1 wt. % of the total weight of the thermoplastic composition (excluding any filler).

Exemplary heat stabilizer additives include organophosphites such as triphenyl phosphite, tris-(2,6-dimethylphenyl)phosphite, tris-(mixed mono- and di-nonylphenyl)phosphite or the like; phosphonates such as dimethylbenzene phosphonate or the like, phosphates such as trimethyl phosphate, or the like, or combinations comprising at least one of the foregoing heat stabilizers. Heat stabilizers can be used in amounts of 0.0001 to 1 parts by weight, based on 100 wt. % of the total weight of the thermoplastic composition (excluding any filler).

Light stabilizers and/or ultraviolet light (UV) absorbing additives can also be used. Exemplary light stabilizer additives include benzotriazoles such as 2-(2-hydroxy-5-methylphenyl)benzotriazole, 2-(2-hydroxy-5-tert-octylphenyl)-benzotriazole and 2-hydroxy-4-n-octoxy benzophenone, or the like, or combinations comprising at least one of the foregoing light stabilizers. Light stabilizers can be used in amounts of 0.0001 to 1 parts by weight, based on 100 wt. % of the total weight of the thermoplastic composition (excluding any filler).

The thermoplastic composition can also include an ultraviolet (UV) absorbing additive, also referred to as a UV absorber. Exemplary compounds for use as UV absorbing additives include hydroxybenzophenones; hydroxybenzotriazoles; hydroxybenzotriazines; cyanoacrylates; oxanilides; benzoxazinones; or a combination comprising at least one of the foregoing. Specifically useful commercially available UV absorbers include TINUVIN® 234, TINUVIN® 329, TINUVIN® 350, and TINUVIN® 360, commercially available from Ciba Specialty Chemicals; 2-(2H-benzotriazol-2-yl)-4-(1,1,3,3-tetramethylbutyl)-phenol (CYASORB® 5411), 2-hydroxy-4-n-octyloxybenzophenone (CYASORB® 531), 2-[4,6-bis(2,4-dimethylphenyl)-1,3,5-triazin-2-yl]-5-(octyloxy)-phenol (CYASORB® 1164), 2,2′-(1,4-phenylene)-bis-(4H-3,1-benzoxazin-4-one) (CYASORB® UV-3638), CYASORB® UV absorbers, available from Cyanamid; and 2,2′-(1,4-phenylene)bis(4H-3,1-benzoxazin-4-one), 1,3-bis[(2-cyano-3,3-diphenylacryloyl)oxy]-2,2-bis[[(2-cyano-3,3-diphenylacryloyl)oxy]methyl]propane, and 1,3-bis[(2-cyano-3,3-diphenylacryloyl)oxy]-2,2-bis[[(2-cyano-3,3-diphenylacryloyl)oxy]methyl]propane (UVINUL® 3030), commercially available from BASF. In addition, UV absorbers can include nano-size inorganic materials such as titanium oxide, cerium oxide, zinc oxide, or the like, all with particle size less than 100 nanometers, can be used. Combinations comprising at least one of the foregoing UV absorbers can be used. UV absorbers can be used in amounts of 0.0001 to 1 wt. % of the total weight of the thermoplastic composition (excluding any filler).

Plasticizers, lubricants, and/or mold release agents can also be used. There is considerable overlap among these types of materials, which include, for example, phthalic acid esters such as dioctyl-4,5-epoxy-hexahydrophthalate; tris-(octoxycarbonylethyl)isocyanurate; tristearin; di- or polyfunctional aromatic phosphates such as resorcinol tetraphenyl diphosphate (RDP), the bis(diphenyl)phosphate of hydroquinone and the bis(diphenyl)phosphate of bisphenol A; poly-alpha-olefins; epoxidized soybean oil; silicones, including silicone oils; esters, for example, fatty acid esters such as alkyl stearyl esters, e.g., methyl stearate; stearyl stearate, pentaerythritol tetrastearate (PETS), and the like; combinations of methyl stearate and hydrophilic and hydrophobic nonionic surfactants comprising polyethylene glycol polymers, polypropylene glycol polymers, and copolymers thereof, e.g., methyl stearate and polyethylene-polypropylene glycol copolymers in a suitable solvent; waxes such as beeswax, montan wax, paraffin wax or the like. Such materials can be used in amounts of 0.001 to 1 wt. % of the total weight of the thermoplastic composition (excluding any filler).

The term “antistatic agent” refers to monomeric, oligomeric, or polymeric materials that can be processed into polymer resins and/or sprayed onto materials or articles to improve conductive properties and overall physical performance. Examples of monomeric antistatic agents include glycerol monostearate, glycerol distearate, glycerol tristearate, ethoxylated amines, primary, secondary and tertiary amines, ethoxylated alcohols, alkyl sulfates, alkylarylsulfates, alkylphosphates, alkylaminesulfates, alkyl sulfonate salts such as sodium stearyl sulfonate, sodium dodecylbenzenesulfonate or the like, quaternary ammonium salts, quaternary ammonium resins, imidazoline derivatives, sorbitan esters, ethanolamides, betaines, or the like, or combinations comprising at least one of the foregoing monomeric antistatic agents.

Exemplary polymeric antistatic agents include certain polyesteramides polyether-polyamide(polyetheramide) block copolymers, polyetheresteramide block copolymers, polyetheresters, or polyurethanes, each containing polyalkylene glycol moieties polyalkylene oxide units such as polyethylene glycol, polypropylene glycol, polytetramethylene glycol, and the like. Such polymeric antistatic agents are commercially available, for example Pelestat® 6321 available from Sanyo, Pebax® MH1657 available from Atofina, or Irgastat® P18 and P22 both available from Ciba-Geigy. Other polymeric materials that can be used as antistatic agents are inherently conducting polymers such as polyaniline (commercially available as PANIPOL®EB from Panipol), polypyrrole and polythiophene (commercially available from Bayer), which retain some of their intrinsic conductivity after melt processing at elevated temperatures. In an embodiment, carbon fibers, carbon nanofibers, carbon nanotubes, carbon black, or any combination of the foregoing can be used in a polymeric resin containing chemical antistatic agents to render the composition electrostatically dissipative. Antistatic agents can be used in amounts of 0.0001 to 5 wt. % of the total weight of the thermoplastic composition (excluding any filler).

Exemplary flame retardants can be organic compounds that include phosphorus, bromine, and/or chlorine. Non-brominated and non-chlorinated phosphorus-containing flame retardants can be preferred in certain applications for regulatory reasons, for example organic phosphates and organic compounds containing phosphorus-nitrogen bonds.

One type of exemplary organic phosphate is an aromatic phosphate of the formula (GO)₃P═O, wherein each G is independently an alkyl, cycloalkyl, aryl, alkylaryl, or arylalkyl group, provided that at least one G is an aromatic group. Two of the G groups can be joined together to provide a cyclic group, for example, diphenyl pentaerythritol diphosphate. Other aromatic phosphates can be, for example, phenyl bis(dodecyl)phosphate, phenyl bis(neopentyl)phosphate, phenyl bis(3,5,5′-trimethylhexyl)phosphate, ethyl diphenyl phosphate, 2-ethylhexyl di(p-tolyl)phosphate, bis(2-ethylhexyl) p-tolyl phosphate, tritolyl phosphate, bis(2-ethylhexyl)phenyl phosphate, tri(nonylphenyl)phosphate, bis(dodecyl)p-tolyl phosphate, dibutyl phenyl phosphate, 2-chloroethyl diphenyl phosphate, p-tolyl bis(2,5,5′-trimethylhexyl)phosphate, 2-ethylhexyl diphenyl phosphate, or the like. A specific aromatic phosphate is one in which each G is aromatic, for example, triphenyl phosphate, tricresyl phosphate, isopropylated triphenyl phosphate, and the like.

Di- or polyfunctional aromatic phosphorus-containing compounds are also useful, for example, compounds of the formulas below:

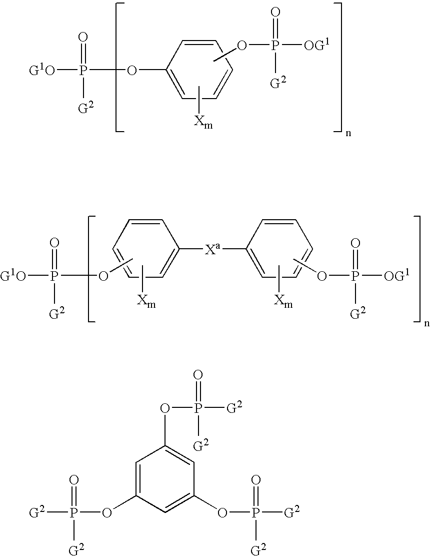

wherein each G¹ is independently a hydrocarbon having 1 to 30 carbon atoms; each G² is independently a hydrocarbon or hydrocarbonoxy having 1 to 30 carbon atoms; each X^{a} is independently a hydrocarbon having 1 to 30 carbon atoms; each X is independently a bromine or chlorine; m is 0 to 4, and n is 1 to 30. Examples of di- or polyfunctional aromatic phosphorus-containing compounds include resorcinol tetraphenyl diphosphate (RDP), the bis(diphenyl)phosphate of hydroquinone and the bis(diphenyl)phosphate of bisphenol A, respectively, their oligomeric and polymeric counterparts, and the like.

Exemplary flame retardant compounds containing phosphorus-nitrogen bonds include phosphonitrilic chloride, phosphorus ester amides, phosphoric acid amides, phosphonic acid amides, phosphinic acid amides, tris(aziridinyl)phosphine oxide. When present, phosphorus-containing flame retardants can be present in amounts of 0.1 to 10 wt. % of the total weight of the thermoplastic composition (excluding any filler).

Halogenated materials can also be used as flame retardants, for example halogenated compounds and resins of formula (7):

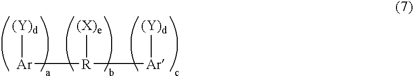

wherein R is an alkylene, alkylidene or cycloaliphatic linkage, e.g., methylene, ethylene, propylene, isopropylene, isopropylidene, butylene, isobutylene, amylene, cyclohexylene, cyclopentylidene, or the like; or an oxygen ether, carbonyl, amine, or a sulfur containing linkage, e.g., sulfide, sulfoxide, sulfone, or the like. R can also consist of two or more alkylene or alkylidene linkages connected by such groups as aromatic, amino, ether, carbonyl, sulfide, sulfoxide, sulfone, or the like.

Ar and Ar′ in formula (7) are each independently mono- or polycarbocyclic aromatic groups such as phenylene, biphenylene, terphenylene, naphthylene, or the like.

Y is an organic, inorganic, or organometallic group, for example: halogen, e.g., chlorine, bromine, iodine, fluorine; ether groups of the general formula OX′, wherein X′ is a monovalent hydrocarbon group similar to X; monovalent hydrocarbon groups of the type represented by R; or other substituents, e.g., nitro, cyano, and the like, said substituents being essentially inert provided that there is at least one and preferably two halogen atoms per aryl nucleus.

When present, each X is independently a monovalent hydrocarbon group, for example an alkyl group such as methyl, ethyl, propyl, isopropyl, butyl, decyl, or the like; an aryl groups such as phenyl, naphthyl, biphenyl, xylyl, tolyl, or the like; and arylalkyl group such as benzyl, ethylphenyl, or the like; a cycloaliphatic group such as cyclopentyl, cyclohexyl, or the like. The monovalent hydrocarbon group can itself contain inert substituents.

Each d is independently 1 to a maximum equivalent to the number of replaceable hydrogens substituted on the aromatic rings comprising Ar or Ar′. Each e is independently 0 to a maximum equivalent to the number of replaceable hydrogens on R. Each a, b, and c is independently a whole number, including 0. When b is not 0, neither a nor c can be 0. Otherwise either a or c, but not both, can be 0. Where b is 0, the aromatic groups are joined by a direct carbon-carbon bond.

The hydroxyl and Y substituents on the aromatic groups, Ar and Ar′, can be varied in the ortho, meta or para positions on the aromatic rings and the groups can be in any possible geometric relationship with respect to one another.

Included within the scope of the above formula are bisphenols of which the following are representative: 2,2-bis-(3,5-dichlorophenyl)-propane; bis-(2-chlorophenyl)-methane; bis(2,6-dibromophenyl)-methane; 1,1-bis-(4-iodophenyl)-ethane; 1,2-bis-(2,6-dichlorophenyl)-ethane; 1,1-bis-(2-chloro-4-iodophenyl)ethane; 1,1-bis-(2-chloro-4-methylphenyl)-ethane; 1,1-bis-(3,5-dichlorophenyl)-ethane; 2,2-bis-(3-phenyl-4-bromophenyl)-ethane; 2,6-bis-(4,6-dichloronaphthyl)-propane; 2,2-bis-(2,6-dichlorophenyl)-pentane; 2,2-bis-(3,5-dibromophenyl)-hexane; bis-(4-chlorophenyl)-phenyl-methane; bis-(3,5-dichlorophenyl)-cyclohexylmethane; bis-(3-nitro-4-bromophenyl)-methane; bis-(4-hydroxy-2,6-dichloro-3-methoxyphenyl)-methane; and 2,2-bis-(3,5-dichloro-4-hydroxyphenyl)-propane 2,2 bis-(3-bromo-4-hydroxyphenyl)-propane. Also included within the above structural formula are: 1,3-dichlorobenzene, 1,4-dibromobenzene, 1,3-dichloro-4-hydroxybenzene, and biphenyls such as 2,2′-dichlorobiphenyl, polybrominated 1,4-diphenoxybenzene, 2,4′-dibromobiphenyl, and 2,4′-dichlorobiphenyl as well as decabromo diphenyl oxide, and the like.

Also useful are oligomeric and polymeric halogenated aromatic compounds, such as a copolycarbonate of bisphenol A and tetrabromobisphenol A and a carbonate precursor, e.g., phosgene. Metal synergists, e.g., antimony oxide, can also be used with the flame retardant. When present, halogen-containing flame retardants can be present in amounts of 0.1 to 10 wt. % of the total weight of the thermoplastic composition (excluding any filler).

Inorganic flame retardants can also be used, for example salts of C₁₋₁₆ alkyl sulfonate salts such as potassium perfluorobutane sulfonate (Rimar salt), potassium perfluoroctane sulfonate, tetraethylammonium perfluorohexane sulfonate, and potassium diphenylsulfone sulfonate, and the like; salts formed by reacting for example an alkali metal or alkaline earth metal (for example lithium, sodium, potassium, magnesium, calcium and barium salts) and an inorganic acid complex salt, for example, an oxo-anion, such as alkali metal and alkaline-earth metal salts of carbonic acid, such as Na₂CO₃, K₂CO₃, MgCO₃, CaCO₃, and BaCO₃ or fluoro-anion complexes such as Li₃AlF₆, BaSiF₆, KBF₄, K₃AlF₆, KAlF₄, K₂SiF₆, and/or Na₃AlF₆ or the like. When present, inorganic flame retardant salts can be present in amounts of 0.1 to 5 parts by weight, based on 100 wt. % of the total weight of the thermoplastic composition (excluding any filler).

Anti-drip agents can also be used, for example a fibril forming or non-fibril forming fluoropolymer such as polytetrafluoroethylene (PTFE). The anti-drip agent can be encapsulated by a rigid copolymer as described above, for example styrene-acrylonitrile copolymer (SAN). PTFE encapsulated in SAN is known as TSAN. Encapsulated fluoropolymers can be made by polymerizing the encapsulating polymer in the presence of the fluoropolymer, for example an aqueous dispersion. TSAN can provide significant advantages over PTFE, in that TSAN can be more readily dispersed in the composition. An exemplary TSAN can comprise, for example, 50 wt. % PTFE and 50 wt. % SAN, based on the total weight of the encapsulated fluoropolymer. The SAN can comprise, for example, 75 wt. % styrene and 25 wt. % acrylonitrile based on the total weight of the copolymer. Alternatively, the fluoropolymer can be pre-blended in some manner with a second polymer, such as for, example, an aromatic polycarbonate resin or SAN to form an agglomerated material for use as an anti-drip agent. Either method can be used to produce an encapsulated fluoropolymer. Antidrip agents can be used in amounts of 0.1 to 5 wt. % of the total weight of the thermoplastic composition (excluding any filler).

In some embodiments, the thermoplastic compositions comprise a polyestercarbonate copolymer, optionally a polycarbonate, and a multifunctional epoxy compound. Combinations comprising a mixture of two or more polyestercarbonate copolymers and polycarbonates can also be used. When a polycarbonate is present, the thermoplastic composition can comprise the polyestercarbonate copolymer(s) and the polycarbonate(s) in a weight ratio of 10:90 to 90:10, more specifically 20:80 to 80:20.

In one embodiment, the thermoplastic compositions consist essentially of a polyestercarbonate copolymer and a multifunctional epoxy compound, together with one or more additives as described above. In another embodiment, the thermoplastic compositions consist essentially of a polyestercarbonate copolymer, a polycarbonate, and a multifunctional epoxy compound, together with one or more additives as described above. As used herein, “consists essentially of” means that no polymers other than the listed polymers, the polymeric epoxy compounds, or the polymeric additives are present in the compositions.

The above thermoplastic compositions (or articles prepared therefrom) can exhibit a number of desirable properties. The thermoplastic composition from which an article for testing is molded can contain additives typically included with polycarbonates, such as mold release agents and antioxidants, wherein the presence of these additives, when in an amount effective to perform the intended function, does not significantly adversely affect the desired properties such as hydrolytic stability and transparency of the thermoplastic composition. Typically the total amount of these additives is less than or equal to 5.0 wt. %, specifically less than or equal to 1 wt. %, of the total weight of components present in thermoplastic composition. In a specific embodiment, additives present in the thermoplastic composition used to prepare a molded article for optical testing (haze and/or percent transmission) can include, 0.2 to 0.6 wt. % of a mold release agent such as pentaerythritol tetrastearate, and 0.01 to 0.1 wt. % of an antioxidant such as tris(2,6-di-tert-butylphenyl)phosphite.

The thermoplastic compositions can have a percent haze of less than or equal to 10%, more specifically less than or equal to 5%, and even more specifically less than or equal to 3%, when measured at a thickness of 3.2 mm according to ASTM D1003-00.

The thermoplastic compositions can also have good mechanical properties, e.g., a heat deformation temperature (HDT) of 110 to 170° C. when measured at 1.8 mega-Pascals (MPa) according to ISO 179; a Notched Izod Impact (NII) strength of 400 to 1,000 Joules per meter (J/m), when measured according to ASTM D256-04 at 23° C.; and/or a % tensile elongation of 30 to 120%, when measured in accordance with ASTM D256-04.

In some embodiments, the thermoplastic compositions have improved hydrolytic stability, particularly as reflected by improved transparency retention. In some embodiments, the thermoplastic compositions do not show a significant decrease in transparency after hydrolytic aging at high temperature and humidity, for example, in an autoclave, over an extended period of time. In one embodiment, a test article having a thickness of 3.2 mm and molded from the thermoplastic composition is more transparent after hydrolytic aging at 134° C. and 100% humidity for 72 hours than an article having a thickness of 3.2 mm and molded from the same thermoplastic composition without the polymeric compound comprising at least two epoxy groups.

In some embodiments, the thermoplastic compositions have a weight average molecular weight loss of less than 2%, or more specifically, less than 1%, after hydrolytic aging at 134° C. and 100% humidity for 6 hours, as measured by GPC.

In one embodiment, a test article having a thickness of 3.2 mm and molded from the thermoplastic compositions retains more ductility after aging at 134° C. and 100% humidity for 48 hours than an article having a thickness of 3.2 mm and molded from the same thermoplastic composition without the polymeric compound comprising at least two epoxy groups.

Specifically, a test article having a thickness of 3.2 mm and molded from the thermoplastic compositions retains at least 40%, or more specifically, at least 50%, or more specifically, at least 60%, or even more specifically, at least 70%, of its ductility after aging at 134° C. and 100% humidity for 48 hours, when measured at a thickness of 3.2 mm in accordance with ASTM D3763-02.

In another embodiment, a test article having a thickness of 3.2 mm and molded from the thermoplastic composition retains at least 20%, or more specifically, at least 30%, or more specifically, at least 40%, or even more specifically, at least 50%, of its ductility after aging at 134° C. and 100% humidity for 72 hours, measured in accordance with ASTM D3763-02.

The thermoplastic compositions can further show fewer microcracks after heat aging, or substantially no microcracking after heat aging, as observed at a magnification of 8.1 times (“×”). In one embodiment, a disk having 10.16 cm (4 inch) diameter comprising the above thermoplastic composition shows substantially no microcracks after hydrolytic aging in an autoclave at 134° C. and 100% humidity for 24 hours. In another embodiment, an article comprising the composition shows substantially no microcracks after hydrolytic aging in an autoclave at 134° C. and 100% humidity for 72 hours. As used herein, “substantially no microcracks” means fewer than 5 microcracks per cm², or more specifically, fewer than 1 microcrack per cm² upon visual observation with the aid of a microscope at the magnification of 8.1 times. This improvement of the appearance after hydrolytic aging is significant, allowing these molded articles to be used in repeat-use applications.

Improved hydrolytic stability is also reflected in improved molecular weight after hydrolytic aging at high temperature and humidity. In one embodiment, the thermoplastic composition has a weight average molecular weight loss of less than 2%, or more specifically, less than 1%, or even more specifically, less than 0.3%, after hydrolytic aging in an autoclave at 134° C. and 100% humidity for 6 hours, as measured by GPC.

An article comprising the above thermoplastic composition can also show a substantially lower increase in haze units than compositions comprising no epoxy compound after hydrolytic aging. In one embodiment, the increase of haze unit is less than 5, or more specifically, less than 3, or even more specifically, or more specifically, less than 2, after hydrolytic aging in an autoclave at 134° C. and 100% humidity for 48 hours. Alternatively, or in addition, the increase of haze unit is less than 30, or more specifically, less than 20, even more specifically, less than 10, or even more specifically, less than 3, after hydrolytic aging in an autoclave at 134° C. and 100% humidity for 72 hours.

In one embodiment, a test article having a thickness of 3.2 mm and molded from the above thermoplastic compositions shows no warp or substantially no warp after hydrolytic aging, for example in an autoclave at 134° C. and 100% humidity for 72 hours. In another embodiment, a test article having a thickness of 3.2 mm and molded from the thermoplastic composition warps less after aging at 134° C. and 100% humidity for 48 hours than an identical article but without the polymeric compound comprising at least two epoxy groups. In yet another embodiment, a test article having a thickness of 3.2 mm and molded from the thermoplastic composition warps less after aging at 134° C. and 100% humidity for 72 hours than an identical article but without the polymeric compound comprising at least two epoxy groups.

The thermoplastic compositions can be manufactured by methods generally available in the art, for example, melt blending in an extruder. In an embodiment, in one manner of proceeding, polycarbonate, polyester-polycarbonate copolymer, any additional polymer, and other additives are first blended, in a HENSCHEL-Mixer® high speed mixer. Other low shear processes including but not limited to hand mixing and mixing in a paint shaker can also accomplish this blending. The blend is then fed into the throat of an extruder, e.g., a twin-screw extruder via a hopper. Alternatively, at least one of the components can be incorporated into the composition by feeding directly into the extruder at the throat and/or downstream through a sidestuffer. Where desired, the polycarbonate, polyester-polycarbonate, and any desired additional resin and/or additives can also be compounded into a masterbatch and combined with a desired polymeric resin and fed into the extruder. The extruder is generally operated at a temperature higher than that necessary to cause the composition to flow, e.g., at a temperature of 180 to 385° C., specifically 200 to 330° C., more specifically 220 to 300° C., wherein the die temperature can be different. The extrudate is immediately quenched in a water batch and pelletized. The pellets, so prepared, when cutting the extrudate can be one-fourth inch long or less as desired. Such pellets can be used for subsequent molding, shaping, or forming.

The compositions described above can be formed, shaped or molded into articles using common thermoplastic processes such as film and sheet extrusion, injection molding, gas-assist injection molding, extrusion molding, compression molding, blow molding, and the like. Thermoplastic substrates can be molded using one of the above processes. Single or multiple layers of coatings can further be applied to the thermoplastic substrates to impart additional properties such as scratch resistance, ultraviolet light resistance, aesthetic appeal, lubricity, and biocompatibility. Coatings can be applied through standard application techniques such as rolling, spraying, dipping, brushing, or flow coating.

Those skilled in the art will also appreciate that common curing and surface modification processes including but not limited to heat-setting, texturing, embossing, corona treatment, flame treatment, plasma treatment and vacuum deposition can further be applied to the above articles to alter surface appearances and impart additional functionalities to the articles.

The articles are useful in a variety of applications, for example computer and business machine housings such as housings for monitors, handheld electronic device housings such as housings for cell phones, electrical connectors, and components of lighting fixtures, ornaments, home appliances, roofs, greenhouses, sun rooms, swimming pool enclosures, and the like. In addition, the polycarbonate compositions can be used for medical application such as specimen containers, pill bottles, syringe barrels, animal caging, medical trays, medical tools, blood housings, vials, caps, tubing, respiratory masks, syringe plungers, and the like.

The thermoplastic composition is further illustrated by the following non-limiting examples.

### EXAMPLES

The materials listed in Table 1 were used in the examples.

TABLE 1

| Material Name | Description | Manufacturer |
|---|---|---|
| PC-I-1 | Bisphenol A polycarbonate, Mw = 30,000 g/mol | GE Plastics |
| PC-I-2 | Bisphenol A polycarbonate, Mw = 22,000 g/mol | GE Plastics |
| PEC-II | Polyestercarbonate copolymer (80% of total (x and y) units | GE Plastics |
| | are x, where x is derived from 93% isophthaloyl and 7% | |
| | terephthaloyl units, and where, x + y = 100), Mw = 28,500 | |
| | g/mol | |
| PETS | Pentaerythritol tetrastearate (plasticizer/mold release agent) | FACI |
| | | Farasco-Genova Italy |
| I-168 | Tris (2,6-di-tert-butylphenyl)phosphite (IRGAFOS ® 168; | Ciba Specialty |
| | antioxidant) | Chemicals |
| E-1 | 3,4-epoxycyclohexylmethyl-3,4- | Union Carbide |
| | epoxycyclohexanecarboxylate | Corporation |
| E-2 | Styrene-acrylate polymer with glycidyl side chains | Johnson Polymer |
| | (Joncryl ® ADR 4368) | LLC |

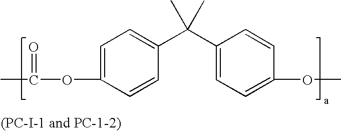

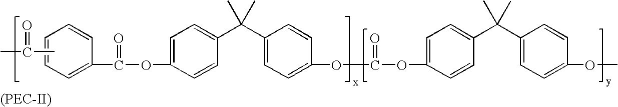

The compositions were prepared by compounding on a Werner and Pfleiderer 30 mm intermeshing twin-screw extruder at 300 rpm with barrel temperatures of 245 to 310° C. The circular disks and rectangular bars used for this study were molded on a Van Dorn Molding machine at a melt temperature of 260 to 310° C. and a mold temperature of 80 to 90° C. Physical measurements were made using the above-described test methods. Weight average molecular weight of the polycarbonates and polyestercarbonates were determined via GPC using polycarbonate standards.

### Examples 1 to 2 and Comparative Examples A to B

The hydrolytic stability of articles made from thermoplastic compositions comprising a polyestercarbonate copolymer, optionally a polycarbonate, and a multifunctional epoxy compound were studied in Examples 1 to 2 (Exs. 1 to 2), versus the same composition with no epoxy compound in Comparative Examples A to B (CE. A and B). Each composition further contained 0.18 to 0.3 wt. % PETS and 0.06 to 0.10 wt. % I-168, each based on the total weight of the polymers in the composition.

Samples molded from the compositions were transparent. The samples were studied for hydrolytic stability. Percent loss of Mw was determined after aging for 6 hours at 134° C., 100% relative humidity in an autoclave. Mw was measured by GPC using polycarbonate standards. Appearance after aging was observed after aging for 24 hours at 134 to 136° C., 100% relative humidity in an autoclave. Results are shown in Table 2 below.

TABLE 2

| | Resin | Resin | Epoxy | Mw | % Mw loss | |
|---|---|---|---|---|---|---|
| Ex. No. | (wt %)^{a} | (wt %)^{a} | (wt %)^{b} | (g/mol) | after aging | Appearance after aging |
| Ex. 1 | PEC-II | — | E-1 (0.12) | 28176 | 0.2 | transparent, no |
| | (100) | | | | | microcracks |
| Ex. 2 | PEC-II | PC-I-1 | E-1 (0.12) | 28592 | 0.3 | transparent, no |
| | (60) | (40) | | | | microcracks |
| CE. A | PEC-II | — | — | 28176 | 3.4 | hazy, microcracks |
| | (100) | | | | | |
| CE. B | PEC-II | PC-I-1 | — | 28682 | 2.9 | hazy, microcracks |
| | (60) | (40) | | | | |

^{a}Based on the total weight of polymeric resins
^{b}Based on the total weight of the resins in the composition

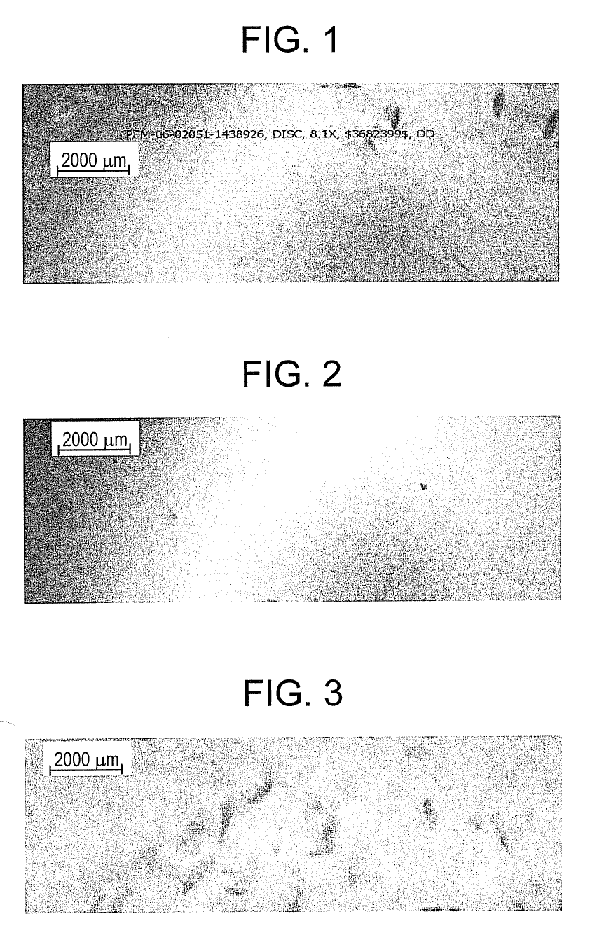

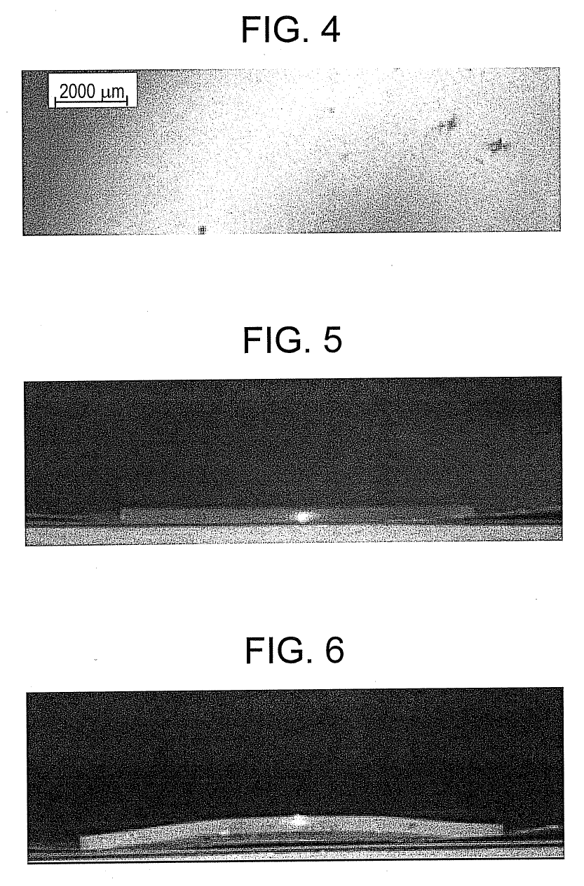

As can be seen from the data in Table 2, the addition of a multifunctional epoxy compound (E-1) improves the hydrolytic stability of the thermoplastic compositions, in particular molecular weight retention. Also, it has been surprisingly found that the addition of E-1 also promotes retention of transparency and prevents the formation of small, sparkling microcracks within the molded article, either with or without a polycarbonate, as shown in FIGS. 1 to 4. This improvement is significant, allowing these compositions to be employed in repeat-use applications, particularly where the articles are autoclaved multiple times, and transparency is a requirement.

### Examples 3 to 6 and Comparative Example C

The hydrolytic stability of the articles made from thermoplastic compositions comprising a blend of a polyestercarbonate copolymer, different polycarbonates, and varying amounts of different multifunctional epoxy material was studied in Examples 3 to 6, versus a thermoplastic composition with no epoxy compound (Comparative Example C). The compositions and results are shown in Table 3.

Haze was measured using a 3.2 mm thick, 102 mm diameter disk, before and after heat aging for 48 and 72 hours, respectively, at 134° C., 100% relative humidity in an autoclave.

TABLE 3

| | | | | | Haze unit | Haze unit |
|---|---|---|---|---|---|---|
| Ex. | Resin | Resin | Epoxy | Initial | increase after | increase after |
| No. | (wt. %)^{a} | (wt. %)^{a} | (wt. %)^{b} | Haze | aging 48 hours | aging 72 hours |
| Ex. 3 | PEC-II (60) | PC-I-1 (40) | E-1 (0.12) | 0.8 | 1.2 | 4.3 |
| Ex. 4 | PEC-II (60) | PC-I-1 (40) | E-2 (0.12) | 0.8 | 1.8 | 8.7 |
| Ex. 5 | PEC-II (60) | PC-I-1 (40) | E-2 (0.24) | 0.7 | 0.6 | 2.4 |
| Ex. 6 | PEC-II (60) | PC-I-1 (40) | E-2 (0.48) | 0.8 | 1.4 | 7.1 |
| CE. C | PEC-II (60) | PC-I-1 (40) | — | 1.0 | 8.0 | 38.8 |

^{a}Based on the total weight of the polymeric resins
^{b}Based on the total weight of the polymeric resins

As can be seen from Table 3, surprisingly, it has been found that the use of multifunctional epoxy compound or polymer (E-1 and E-2, respectively) aids in improving the appearance of polyestercarbonate blends with polycarbonates after an extended period of time in the autoclave. Example 5, which contained 0.24 wt. % of E-2, appears to best maintain transparency (lowest haze unit increase) compared to all of the other formulations. Comparative Example C had approximately a 40-fold increase in haze after 72 hours in the autoclave compared to the initial molded article. Comparative Example C was also warped and displayed microcracks after 48 hours and 72 hours in the autoclave. In contrast, Examples 3 to 6 remained completely transparent, did not have microcracks, and did not warp.

### Examples 7 to 8 and Comparative Example D

The hydrolytic stabilities and high temperature stability of articles made from thermoplastic compositions comprising a blend of a polyestercarbonate, a polycarbonate, and a multifunctional epoxy material were studied in Examples 7 to 8, versus articles made from thermoplastic compositions with no epoxy compound (Comparative Example D).

Dynatup ductility (Total E) was measured on a 3.2 mm thick, 102 mm diameter disk according to ASTM D3763-02 before and after heat aging at 134° C. and 100% humidity in an autoclave.

HDT was measured on a 3.2 mm thick rectangular article according to ASTM D648.

Haze was measured using a 3.2 mm thick, 102 mm diameter disk, before and after heat aging for 48 and 72 hours, respectively, at 134° C., 100% relative humidity in an autoclave. The compositions and results are shown in Table 4.

TABLE 4

| | | | | | Total E (J) | Total E (J) | | Haze unit |
|---|---|---|---|---|---|---|---|---|
| | Resin | Resin | Epoxy | Total E^{b} | after aging | after aging | HDT | increase after |
| Ex. No. | (wt %)^{a} | (wt %)^{a} | (wt %)^{b} | (J) | 48 h | 72 h | (1.8 MPa) | aging 48 h |
| Ex. 7 | PEC-II | PC-I-1 | E-1 (0.12) | 82.3 | 65 | 48.8 | 143 | 1.2 |
| | (60) | (40) | | | | | | |
| Ex. 8 | PEC-II | PC-I-1 | E-2 (0.12) | 76.2 | 56.6 | 17.9 | 143 | 1.8 |
| | (60) | (40) | | | | | | |
| CE. D | PEC-II | PC-I-1 | — | 81.8 | 1.76 | 1.05 | 143 | 8 |
| | (60) | (40) | | | | | | |

^{a}Based on the total weight of the polymeric resins
^{b}Based on the total weight of the polymeric resins

A series of materials with similar HDT's was analyzed for retention of ductility and optical properties after hydrolytic aging in the autoclave. Examples 7 and 8 show greatly improved ductility retention and optical properties compared to Comparative Example D, which had no epoxy-functional compound.

FIG. 5 shows that a disc molded from the composition of Example 8 did not warp after 72 hours at 134° C. in an autoclave. In contrast, it can be seen from FIG. 6 that a disc molded from the composition of Example D warped after 72 hours at 134° C. in an autoclave.

These data show that the combination of a multifunctional epoxy material with a high heat polymeric material derived from polyester units as well as polycarbonate units has better hydrolytic stability than similar high heat polycarbonate materials that do not contain an epoxy-functional compound. Additional experiments (data not shown) showed that even in the presence of multifunctional epoxy material, the improved retention was lost when ester units were not present.

As used herein, the term “combination” is inclusive of blends, mixtures, alloys, reaction products, and the like. The singular forms “a,” “an,” and “the” include plural referents unless the context clearly dictates otherwise. The endpoints of all ranges reciting the same characteristic or component are independently combinable and inclusive of the recited endpoint. All references are incorporated herein by reference.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

What is claimed is:

1. A thermoplastic composition comprising
a polymer component comprising
a polyestercarbonate copolymer comprising
ester units of the formula 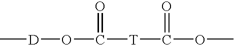
wherein each D and T is independently the same or different divalent
C₆₋₃₀ aromatic organic group; and
carbonate units of the formula 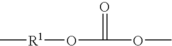
wherein at least about 60 percent of the total number of R¹ groups are a divalent C₆₋₃₆ aromatic organic group, and the balance thereof are C₁₋₃₆ aliphatic, C₅₋₃₆ alicyclic, or C₆₋₃₆ aromatic organic groups; and
0.01 to 10 wt. %, based on the total weight of the polymer component, of a polymeric compound comprising at least two epoxy groups, wherein the polymeric compound has a weight average molecular weight of 1,500 to 18,000;
wherein a test article having a thickness of 3.2 mm and molded from the thermoplastic composition retains more ductility after aging at 134° C. and 100% humidity for 48 hours than an article having a thickness of 3.2 mm and molded from the same thermoplastic composition without the polymeric compound comprising at least two epoxy groups, each measured in accordance with ASTM D3763-02.

2. The thermoplastic composition of claim 1, having a weight average molecular weight loss of less than 2% after hydrolytic aging at 134° C. and 100% humidity for 6 hours, as measured by GPC.

3. The thermoplastic composition of claim 1, wherein a test article having a thickness of 3.2 mm and molded from the thermoplastic composition shows fewer microcracks at a magnification of 8.1× after hydrolytic aging at 134° C. and 100% humidity for 72 hours than an article having a thickness of 3.2 mm and molded from the same thermoplastic composition without the polymeric compound comprising at least two epoxy groups.

4. The thermoplastic composition of claim 1, wherein a test article having a thickness of 3.2 mm and molded from the thermoplastic composition is more transparent after hydrolytic aging at 134° C. and 100% humidity for 72 hours than an article having a thickness of 3.2 mm and molded from the same thermoplastic composition without the polymeric compound comprising at least two epoxy groups.

5. The thermoplastic composition of claim 1, wherein a test article having a thickness of 3.2 mm and molded from the thermoplastic composition has a haze of less than 2.0, measured in accordance with ASTM-D1003-00.

6. The thermoplastic composition of claim 1, wherein a test article having a thickness of 3.2 mm and molded from the thermoplastic composition has an increase in haze units of less than 5 after hydrolytic aging at 134° C. and 100% humidity for 48 hours, measured in accordance with ASTM-D1003-00.

7. The thermoplastic composition of claim 1, wherein a test article having a thickness of 3.2 mm and molded from the thermoplastic composition has an increase in haze units of less than 30 after hydrolytic aging at 134° C. and 100% humidity for 72 hours, measured in accordance with ASTM-D1003-00.

8. The thermoplastic composition of claim 1, wherein a test article having a thickness of 3.2 mm and molded from the thermoplastic composition warps less after aging at 134° C. and 100% humidity for 48 hours than an article having a thickness of 3.2 mm and molded from the same thermoplastic composition without the polymeric compound comprising at least two epoxy groups.

9. The thermoplastic composition of claim 1, wherein a test article having a thickness of 3.2 mm and molded from the thermoplastic composition warps less after aging at 134° C. and 100% humidity for 72 hours than an article having a thickness of 3.2 mm and molded from the same thermoplastic composition without the polymeric compound comprising at least two epoxy groups.

10. The thermoplastic composition of claim 1 wherein a test article having a thickness of 3.2 mm and molded from the thermoplastic composition retains at least 40% of its ductility after aging at 134° C. and 100% humidity for 48 hours, measured in accordance with ASTM D3763-02.

11. The thermoplastic composition of claim 1, wherein the molar ratio of ester units to carbonate units in the polyestercarbonate copolymer is 20:80 to 80:20.

12. The thermoplastic composition of claim 1, wherein the polyestercarbonate copolymer comprises ester units derived from the reaction of a mixture of isophthalic and terephthalic acid or a chemical equivalent thereof and a dihydroxy aromatic compound of the formula 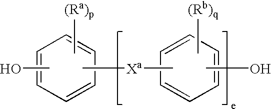
wherein each R^{a} and R^{b} is independently the same or different halogen or C₁₋₁₂ alkyl group; e is 0 or 1; and p and q are each independently integers of 0 to 4, or a chemical equivalent thereof.

13. The thermoplastic composition of claim 12, wherein p and q are 0, e is one, and X^{a} is isopropylidene.

14. The thermoplastic composition of claim 1, wherein the polyestercarbonate copolymer comprises carbonate units derived from a dihydroxy aromatic compound of the formula 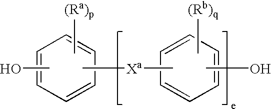
wherein each R^{a} and R^{b} is independently the same or different halogen or C₁₋₁₂ alkyl group; e is 0 or 1; and p and q are each independently integers of 0 to 4.

15. The thermoplastic composition of claim 14, wherein p and q are 0, e is 1, and X^{a} is isopropylidene.

16. The thermoplastic composition of claim 1, wherein the polymer component further comprises a polycarbonate comprising carbonate units of the formula 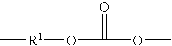
wherein at least about 60 percent of the total number of R¹ groups are a divalent C₆₋₃₆ aromatic organic group, and the balance thereof are C₁₋₃₆ aliphatic, C₅₋₃₆ alicyclic, or C₆₋₃₆ aromatic organic groups.

17. The thermoplastic composition of claim 16, wherein the carbonate units are derived from compounds of the formula 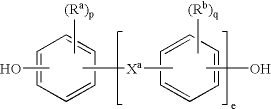
wherein each R^{a} and R^{b} is independently the same or different halogen or C₁₋₁₂ alkyl group; e is 0 or 1; and p and q are each independently integers of 0 to 4.

18. The thermoplastic composition of claim 17, wherein p and q are 0; e is 1, and X^{a} is isopropylidene.

19. The thermoplastic composition of claim 1, wherein the polymeric compound comprising at least two epoxy groups is a copolymer comprising units derived from an epoxy-functional (meth)acrylate monomer and a non-epoxy functional styrenic and/or (C₁₋₈ hydrocarbyl)(meth)acrylate and/or olefin and/or vinyl acetate monomer.

20. The thermoplastic composition of claim 1, wherein the polymeric compound comprising at least two epoxy groups is a copolymer comprising units derived from an epoxy-functional (meth)acrylate monomer, a non-epoxy functional styrenic monomer, and optionally a non-epoxy functional C₁₋₈(hydrocarbyl)(meth)acrylate monomer.

21. A thermoplastic composition comprising
a polymer component comprising
a polyestercarbonate copolymer comprising
ester units derived from the reaction of a mixture of isophthalic and terephthalic acid or a chemical equivalent thereof with a dihydroxy aromatic compound of the formula 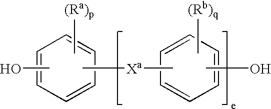
wherein each R^{a} and R^{b} is independently the same or different halogen or C₁₋₁₂ alkyl group; e is 0 or 1; and p and q are each independently integers of 0 to 4, or a chemical equivalent thereof; and
carbonate units derived from the reaction of a dihydroxy aromatic compound of the formula 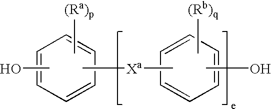
wherein each R^{a} and R^{b} is independently the same or different halogen or C₁₋₁₂ alkyl group; e is 0 or 1; and p and q are each independently integers of 0 to 4, wherein the molar ratio of ester units to carbonate units is 10:90 to 90:10; and
0.01 to 2 wt. %, based on the total weight of the polymer component, of a polymeric compound comprising at least two epoxy groups, wherein the copolymer has a weight average molecular weight of 3,000 to 13,000 Daltons.

22. A thermoplastic composition comprising
a polymer component comprising
a polyestercarbonate copolymer comprising
ester units derived from the reaction of a mixture of isophthalic and terephthalic acid or a chemical equivalent thereof with bisphenol A or a chemical equivalent thereof, and
carbonate units derived from bisphenol A, wherein the molar ratio of ester units to carbonate units is 20:80 to 80:20; and
0.01 to 1 wt. %, based on the total weight of the polymer component, of a styrene-(meth)acrylate polymer with glycidyl side chains, wherein the copolymer has a weight average molecular weight of 4,000 to 8,500 Daltons.

23. A method of manufacturing a thermoplastic composition, comprising
blending the components of the thermoplastic composition of claim 1; and
extruding the blended components.

24. An article comprising the composition of claim 1.

25. The article of claim 24 wherein the article is a specimen container, pill bottle, syringe barrel, animal caging, medical tray, medical tool, blood housing, vial, cap, tubing, respiratory mask, or syringe plunger.

26. A method of manufacturing an article comprising the thermoplastic composition of claim 1, comprising
blending the components of the thermoplastic composition of claim 1;
extruding the blend; and
shaping, forming, or molding the extruded blend to form an article.
